(19) United States
(12) Patent Application Publication
(10) Pub. No.: US 2026/0343595 A1
(43) Pub. Date: Oct. 29, 2026

(54) CHANNEL OCCUPANCY TIME SHARING METHOD AND APPARATUS, AND STORAGE MEDIUM

(71) Applicant: Beijing Xiaomi Mobile Software Co., Ltd., Beijing (CN)

(72) Inventor: Wensu ZHAO, Beijing (CN)

(73) Assignee: Beijing Xiaomi Mobile Software Co., Ltd., Beijing (CN)

(21) Appl. No.: 19/122,379

(22) PCT Filed: Oct. 20, 2022
(86) PCT No.: PCT/CN2022/126531

§ 371 Date: Apr. 18, 2025

(51) Int. Cl. H04W 74/04

(52) U.S. Cl. CPC H04W 74/04

(57) ABSTRACT

The present disclosure relates to a channel occupancy time (COT) sharing method and apparatus, and a storage medium, and belongs to the technical field of communications. The method includes: initiating a COT at a first time; and sending COT sharing information to a second terminal device at a second time, where the second time is determined based on the first time.

### CROSS-REFERENCE TO RELATED APPLICATION

The present application is a U.S. National Stage of International Application No. PCT/CN2022/126531, filed on Oct. 20, 2022, the contents of which are incorporated herein by reference in their entirety.

### TECHNICAL FIELD

The present disclosure relates to the field of communication technology and, in particular, to methods and apparatuses for channel occupancy time (COT) sharing, and storage media.

### BACKGROUND

Communication systems deployed in unlicensed frequency bands typically use or share wireless resources through competition. To ensure fairness, devices transmitting in unlicensed frequency bands usually need to follow a listen-before-talk (LBT) rule, which means that they need to listen to the channel before sending signals. Communication transmission occurs when the channel is detected as idle. When a terminal device performs communication transmission, its occupation of the detected idle channel is not permanent but is determined by an occupation time, which can be referred to as COT. The terminal device occupies the idle unlicensed frequency band within this COT.

In related technologies, terminal devices support COT sharing to fully utilize channel resources. During COT sharing, a terminal device initiating a COT needs to send COT sharing information, and a terminal device sharing a COT needs to determine whether/how to use the COT shared by the terminal device initiating the COT according to the COT sharing information. However, related technologies do not specify how COT sharing information is sent between terminal devices.

### SUMMARY

In order to overcome the problems existing in the related art, the present disclosure provides methods and apparatuses for channel occupancy time sharing, and storage media.

According to a first aspect of an embodiment of the present disclosure, a method for channel occupancy time sharing is provided, which is performed by a first terminal device, and the method includes: initiating a COT at a first time; and sending COT sharing information to a second terminal device at a second time, where the second time is determined based on the first time.

In an implementation, the COT sharing information is sent independently, or the COT sharing information is sent together with communication data of the first terminal device.

In an implementation, the second time is equal to or later than the first time.

In an implementation, in response to determining that the second time is later than the first time, the second time indicates a m-th slot of the COT initiated at the first time, and m is a positive integer greater than 1.

In an implementation, in response to determining that the second time is equal to the first time, the second time indicates a first slot of the COT initiated at the first time.

In an implementation, at least one reserved COT initiated at a third time is included in the COT initiated at the first time; where the third time includes one or more periodic times, or the third time includes one or more aperiodic times.

In an implementation, the COT sharing information carries first indication information, and the first indication information indicates whether the at least one COT initiated at the third time is reserved in the COT initiated at the first time.

In an implementation, in response to determining that the third time includes one or more aperiodic times, a time interval between the third time and the second time is less than or equal to a time threshold.

In an implementation, the time threshold is determined based on at least one of: a predefinition; a pre-configuration; or sidelink control information (SCI).

According to a second aspect of an embodiment of present disclosure, a method for channel occupancy time sharing is provided, which is performed by a second terminal device, and the method includes: receiving COT sharing information sent by a first terminal device at a second time, where the second time is determined based on a first time at which the first terminal device initiates a COT.

In an implementation, the COT sharing information is received independently, or the COT sharing information is received together with communication data of the first terminal device.

In an implementation, the second time is equal to or later than the first time.

In an implementation, in response to determining that the second time is later than the first time, the second time indicates a m-th slot of the COT initiated at the first time, and m is a positive integer greater than 1.

In an implementation, in response to determining that the second time is equal to the first time, the second time indicates a first slot of the COT initiated at the first time.

In an implementation, at least one reserved COT initiated at a third time is included in the COT initiated by the first terminal device at the first time.
where the third time includes one or more periodic times, or the third time includes one or more aperiodic times.

In an implementation, the COT sharing information carries first indication information, and the first indication information indicates whether the at least one COT initiated at the third time is reserved in the COT initiated by the first terminal device at the first time.

In an implementation, in response to determining that the third time includes one or more aperiodic times, a time interval between the third time and the second time is less than or equal to a time threshold.

In an implementation, the time threshold is determined based on at least one of: a predefinition; a pre-configuration; or sidelink control information (SCI).

In an implementation, the method further includes: sending the COT sharing information to a third terminal device.

In an implementation, sending the COT sharing information to the third terminal device includes: sending the COT sharing information to the third terminal device in response to meeting a condition for sending the COT sharing information.

In an implementation, meeting the condition for sending the COT sharing information includes at least one of: a remaining COT length of a shared COT initiated by the first terminal device being not 0; or a multicast or broadcast communication mode being adopted with the first terminal device.

According to a third aspect of an embodiment of present disclosure, an apparatus for channel occupancy time sharing is provided, including: a transceiver module, configured to initiate a COT at a first time; and send COT sharing information to a second terminal device at a second time, where the second time is determined based on the first time.

In an implementation, the COT sharing information is sent independently, or the COT sharing information is sent together with communication data of the first terminal device.

In an implementation, the second time is equal to or later than the first time.

In an implementation, in response to determining that the second time is later than the first time, the second time indicates a m-th slot of the COT initiated at the first time, and m is a positive integer greater than 1.

In an implementation, in response to determining that the second time is equal to the first time, the second time indicates a first slot of the COT initiated at the first time.

In an implementation, at least one reserved COT initiated at a third time is included in the COT initiated at the first time; where the third time includes one or more periodic times, or the third time includes one or more aperiodic times.

In an implementation, the COT sharing information carries first indication information, and the first indication information indicates whether the at least one COT initiated at the third time is reserved in the COT initiated at the first time.

In an implementation, in response to determining that the third time includes one or more aperiodic times, a time interval between the third time and the second time is less than or equal to a time threshold.

In an implementation, the time threshold is determined based on at least one of: a predefinition; a pre-configuration; or sidelink control information (SCI).

According to a fourth aspect of an embodiment of present disclosure, an apparatus for channel occupancy time sharing is provided, including: a transceiver module, configured to receive COT sharing information sent by a first terminal device at a second time, where the second time is determined based on a first time at which the first terminal device initiates a COT.

In an implementation, the COT sharing information is received independently, or the COT sharing information is received together with communication data of the first terminal device.

In an implementation, the second time is equal to or later than the first time.

In an implementation, in response to determining that the second time is later than the first time, the second time indicates a m-th slot of the COT initiated at the first time, and m is a positive integer greater than 1.

In an implementation, in response to determining that the second time is equal to the first time, the second time indicates a first slot of the COT initiated at the first time.

In an implementation, at least one reserved COT initiated at a third time is included in the COT initiated by the first terminal device at the first time; where the third time includes one or more periodic times, or the third time includes one or more aperiodic times.

In an implementation, the COT sharing information carries first indication information, and the first indication information indicates whether the at least one COT initiated at the third time is reserved in the COT initiated by the first terminal device at the first time.

In an implementation, in response to determining that the third time includes one or more aperiodic times, a time interval between the third time and the second time is less than or equal to a time threshold.

In an implementation, the time threshold is determined based on at least one of: a predefinition; a pre-configuration; or sidelink control information (SCI).

In an implementation, the transceiver module is further configured to send the COT sharing information to a third terminal device.

In an implementation, the transceiver module is specifically configured to send the COT sharing information to the third terminal device in response to meeting a condition for sending the COT sharing information.

In an implementation, meeting the condition for sending the COT sharing information includes at least one of: a remaining COT length of a shared COT initiated by the first terminal device being not 0; or a multicast or broadcast communication mode being adopted with the first terminal device.

According to a fifth aspect of an embodiment of the present disclosure, a communication apparatus is provided, including: a processor; and a memory, configured to store processor-executable instructions; where the processor is configured to perform the method described in the first aspect and any one of its implementations.

According to a sixth aspect of an embodiment of the present disclosure, a communication apparatus is provided, including: a processor; and a memory, configured to store processor-executable instructions; where the processor is configured to perform the method described in the second aspect and any one of its implementations.

According to a seventh aspect of an embodiment of the present disclosure, a storage medium is provided, where instructions are stored in the storage medium, and when the instructions in the storage medium are executed by a processor of a first terminal device, enable the first terminal device to perform the method described in the first aspect and any one of its implementations.

According to an eighth aspect of an embodiment of the present disclosure, a storage medium is provided, where instructions are stored in the storage medium, and when the instructions in the storage medium are executed by a processor of a second terminal device, enable the second terminal device to perform the method described in the second aspect and any one of its implementations.

According to a ninth aspect of an embodiment of the present disclosure, a communication system is provided, including a first terminal device and a second terminal device, where the first terminal device is configured to perform the method described in the first aspect and any one of its implementations; and the second terminal device is configured to perform the method described in the second aspect and any one of its implementations.

The technical solution provided by embodiments of the present disclosure may include the following beneficial effect: the first terminal device initiates a COT at a first time; and sends COT sharing information to the second terminal device at a second time. The second time is determined based on the first time. Therefore, in the embodiments of the present disclosure, the first terminal device can determine the time to send the COT sharing information based on the time of initiating the COT. Furthermore, the second terminal device can determine the second time to receive COT sharing information based on the first time when the first terminal device initiates the COT, and then receive the COT sharing information at the second time. This enables the second terminal device to receive and decode the COT sharing information in a timely and accurate manner, facilitating COT sharing based on the COT sharing information and improving the efficiency of COT sharing.

It should be understood that the above general description and the following detailed descriptions are exemplary and explanatory only and do not limit the present disclosure.

### BRIEF DESCRIPTION OF DRAWINGS

The accompanying drawings, which are incorporated in and constitute a part of the specification, illustrate embodiments consistent with the present disclosure, and are used together with the specification to explain the principles of the present disclosure.

FIG. 1 is a schematic diagram of a wireless communication system according to an embodiment of the present disclosure.

FIG. 2 is a flowchart of a method for COT sharing according to an embodiment of the present disclosure.

FIG. 3 is a flowchart of a method for COT sharing according to an embodiment of the present disclosure.

FIG. 4 is a flowchart of a method for COT sharing according to an embodiment of the present disclosure.

FIG. 5 is a flowchart of a method for COT sharing according to an embodiment of the present disclosure.

FIG. 6 is a flowchart of a method for COT sharing according to an embodiment of the present disclosure.

FIG. 7 is a flowchart of a method for COT sharing according to an embodiment of the present disclosure.

FIG. 8 is a flowchart of a method for COT sharing according to an embodiment of the present disclosure.

FIG. 9 is a flowchart of a method for COT sharing according to an embodiment of the present disclosure.

FIG. 10 is a flowchart of a method for COT sharing according to an embodiment of the present disclosure.

FIG. 11 is a flowchart of a method for COT sharing according to an embodiment of the present disclosure.

FIG. 12 is a flowchart of a method for COT sharing according to an embodiment of the present disclosure.

FIG. 13 is a block diagram of an apparatus for COT sharing according to an embodiment of the present disclosure.

FIG. 14 is a block diagram of an apparatus for COT sharing according to an embodiment of the present disclosure.

FIG. 15 is a block diagram of an apparatus configured for COT sharing according to an embodiment of the present disclosure.

### DETAILED DESCRIPTION

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Implementations described in the following embodiments of the present disclosure do not represent all implementations consistent with the present disclosure.

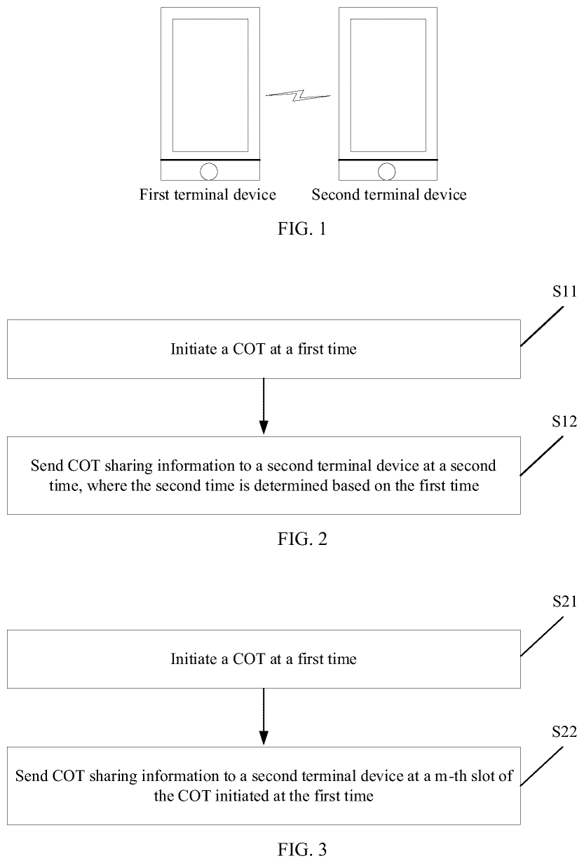

The COT sharing method provided by the embodiments of the present disclosure can be applied to a wireless communication system shown in FIG. 1. Referring to FIG. 1, the wireless communication system includes, but is not limited to, a first terminal device and a second terminal device. The first terminal device is connected to the second terminal device via a wireless resource and transmits data.

In the embodiments of the present disclosure, the first terminal device may also be referred to as a terminal device initiating a COT, and the second terminal device may also be referred to as a terminal device sharing a COT.

It can be understood that the wireless communication system shown in FIG. 1 is only a schematic illustration, and the wireless communication system may also include network devices, such as core network devices, wireless relay devices and wireless backhaul devices, which are not shown in FIG. 1. Embodiments of the present disclosure do not limit the number of terminals included in the wireless communication system.

It can be further understood that the wireless communication system of the embodiments of the present disclosure is a network providing wireless communication functions. The wireless communication system can adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance, etc. According to factors such as capacity, speed, delay of different networks, networks can be divided into 2-Generation (2G) networks, 3G networks, 4G networks or future evolution networks, such as 5G networks, which can also be called new radio (NR) networks. For ease of description, the present disclosure sometimes refers to a wireless communication network simply as a network.

Furthermore, the terminal device involved in the present disclosure, which may also be referred to as a terminal, a user equipment (UE), a mobile station (MS), a mobile terminal (MT), etc., is a device that provides voice and/or data connectivity to a user, e.g., the terminal may be a hand-held device, a vehicle-mounted device, etc., having wireless connectivity. At present, some examples of terminals are: mobile phone, customer front-end equipment, pocket personal computer (PPC), palmtop computer, personal digital assistant (PDA), notebook computer, tablet computer, wearable device, or vehicle-mounted device. In addition, when it is a vehicle networking (V2X) communication system, the terminal device can further be a vehicle-mounted device. It should be understood that the embodiments of the present disclosure do not limit specific technologies and specific device forms adopted by the terminal.

Communication systems deployed in unlicensed frequency bands typically use or share wireless resources through competition. To ensure fairness, devices transmitting in unlicensed frequency bands usually need to follow a listen-before-talk (LBT) rule, which means that they need to listen to the channel before sending signals. Communication transmission occurs when the channel is detected as idle. When a terminal device performs communication transmission, its occupation of the detected idle channel is not permanent but is determined by an occupancy time, which can be referred to as COT. The terminal device occupies the idle unlicensed frequency band within this COT.

In related technologies, terminal devices support COT sharing to fully utilize channel resources. During COT sharing, a terminal device initiating a COT needs to send COT sharing information, and a terminal device sharing a COT needs to determine whether/how to use the COT shared by the terminal device initiating the COT according to the COT sharing information. However, related technologies do not specify how COT sharing information is sent between terminal devices.

Based on this, embodiments of the present disclosure provide a method for COT sharing. A first terminal device initiates a COT at a first time and sends COT sharing information to a second terminal device at a second time. The second time is determined based on the first time. Therefore, in the embodiments of the present disclosure, the first terminal device can determine the time to send the COT sharing information based on the time of initiating the COT. Furthermore, the second terminal device can determine the second time to receive COT sharing information based on the first time when the first terminal device initiates the COT, and then receive the COT sharing information at the second time. This enables the second terminal device to receive and decode the COT sharing information in a timely and accurate manner, facilitating COT sharing based on the COT sharing information and improving the efficiency of COT sharing.

FIG. 2 is a flowchart of a method for COT sharing according to an embodiment of the present disclosure. As shown in FIG. 2, the method for COT sharing is performed by a first terminal device and includes the following steps.

At step S11, initiating a COT at a first time.

At step S12, sending COT sharing information to a second terminal device at a second time, where the second time is determined based on the first time.

In the embodiment of the present disclosure, the first terminal device initiates the COT at the first time and sends the COT sharing information to the second terminal device at the second time. The second time is determined based on the first time. Therefore, in the embodiment of the present disclosure, the first terminal device can determine the time to send the COT sharing information based on the time of initiating the COT. Furthermore, the second terminal device can determine the second time to receive COT sharing information based on the first time when the first terminal device initiates the COT, and then receive the COT sharing information at the second time. This enables the second terminal device to receive and decode the COT sharing information in a timely and accurate manner, facilitating COT sharing based on the COT sharing information and improving the efficiency of COT sharing.

In an implementation, the COT sharing information includes at least one of: a COT remaining length, a COT ID, a channel access mode, a channel access priority.

For example, the first terminal device may use a Type 1 Listen-Before-Talk (LBT) mode to access the channel and initiate a COT of a certain length. Depending on the specific situation, the COT remaining length is determined, and the COT sharing information including at least one of the COT remaining length, COT ID, and channel access mode is carried during communication with the second terminal device.

The COT remaining length can be understood as a length of the COT available for use by the second terminal device and can be determined by the first terminal device based on different situations.

In the method for COT sharing provided in the embodiment of the present disclosure, the COT sharing information can be sent independently or together with communication data of the first terminal device.

In an implementation, the COT sharing information can be carried through direct communication to send the COT sharing information to the second terminal device; or, the COT sharing information can be carried through a Medium Access Control Control Element (MAC CE) to send the COT sharing information to the second terminal device.

In the method for COT sharing provided in the embodiment of the present disclosure, the second time is equal to or later than the first time.

In an implementation of the method for COT sharing provided in the embodiment of the present disclosure, if the second time is later than the first time, the second time indicates a m-th slot of the COT initiated at the first time, and m is an integer greater than 1.

FIG. 3 is a flowchart of a method for COT sharing according to an embodiment of the present disclosure. As shown in FIG. 3, the method includes the following steps.

At step S21, initiating a COT at a first time.

At step S22, sending COT sharing information to a second terminal device at a m-th slot of the COT initiated at the first time.

In another implementation of the method for COT sharing provided in the embodiment of the present disclosure, if the second time is equal to the first time, the second time indicates a first slot of the COT initiated at the first time.

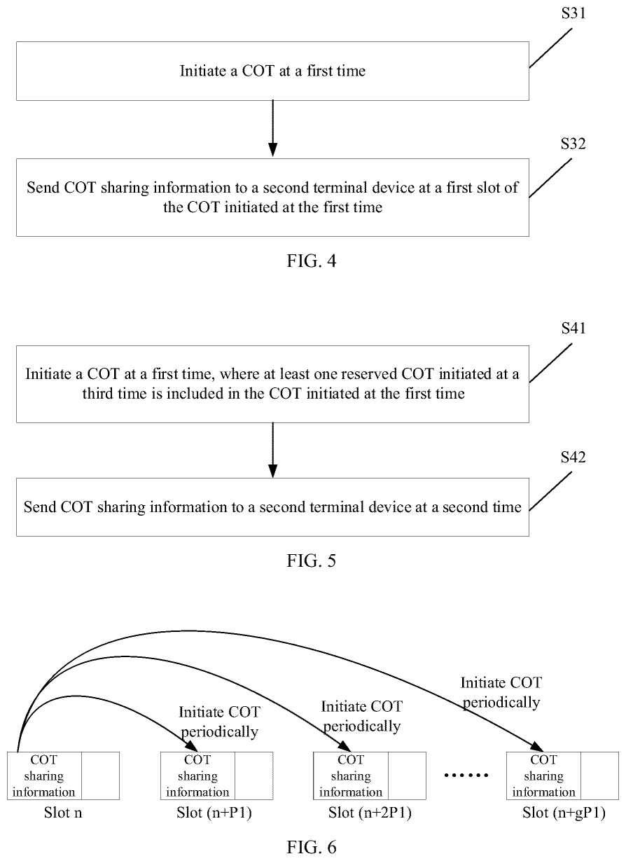

FIG. 4 is a flowchart of a method for COT sharing according to an embodiment of the present disclosure. As shown in FIG. 4, the method includes the following steps.

At step S31, initiating a COT at a first time.

At step S32, sending COT sharing information to a second terminal device at a first slot of the COT initiated at the first time.

In the embodiment of the present disclosure, by sending the COT sharing information to the second terminal device at the first slot of the COT initiated by the first terminal device, the second terminal device can promptly receive the COT sharing information and determine start position and end position of the COT used by the second terminal device, thereby reducing the time delay in decoding the COT sharing information.

In the embodiment of the present disclosure, each time the first terminal device initiates COT sharing, the first terminal device will send COT sharing information to the second terminal device once at the first or m-th slot after initiating the COT, that is, the number of times the first terminal device initiates COT sharing is the same as the number of times the first terminal device sends COT sharing information.

In the method for COT sharing provided in the embodiment of the present disclosure, at least one reserved COT to be initiated at a third time is included in the COT initiated at the first time.

The third time includes one or more periodic times, or the third time includes one or more aperiodic times.

FIG. 5 is a flowchart of a method for COT sharing according to an embodiment of the present disclosure. As shown in FIG. 5, the method includes the following steps.

At step S41, initiating a COT at a first time, where at least one reserved COT initiated at a third time is included in the COT initiated at the first time.

At step S42, sending COT sharing information to a second terminal device at a second time.

It should be noted that steps S41-S42 can be implemented independently, or together with any embodiment of the present disclosure, and will not be repeated here.

In the embodiment of the present disclosure, the number of times the first terminal device initiates a COT and the number of times the first terminal device sends COT sharing information are different. The first terminal device will reserve the at least one COT initiated at the third time when initiating the COT at the first time. It can be understood that after initiating a COT sharing at a certain time, the first terminal device sends COT sharing information to the second terminal device once at the second time. Thereafter, when the first terminal device initiates the COT at the third time, the first terminal device will not send the COT sharing information to the second terminal device, and the second terminal device will directly use the reserved COT.

In the embodiment of the present disclosure, the length of the COT initiated at the first time and the reserved COT initiated at the third time are the same.

In the method for COT sharing provided in the embodiment of the present disclosure, the COT sharing information carries first indication information, and the first indication information indicates whether the at least one COT initiated at the third time is reserved in the COT initiated at the first time.

In an implementation of the method for COT sharing provided in the embodiment of the present disclosure, the first indication information includes bit information, and whether the at least one COT initiated at the third time is reserved is indicated by the bit information.

In an embodiment of the present disclosure, in response to the bit information being 1, the first terminal device reserves at least one COT initiated at the third time in the COT initiated at the first time. Or, in response to the bit information being 0, the first terminal device does not reserve at least one COT initiated at the third time in the COT initiated at the first time.

In the method for COT sharing provided in the embodiment of the present disclosure, in response to the at least one COT initiated at the third time is reserved in the COT initiated at the first time, it is determined that the third time includes one or more periodic times or one or more aperiodic times.

An implementation is to determine whether the third time is a periodic time based on first-stage sidelink control information (SCI).

In an embodiment of the present disclosure, if a resource reservation period-┌log₂ N_{rsv_period}┐ information field exists in the first stage SCI, the third time is determined to be a periodic time, and a period of the third time is determined based on ┌log₂ N_{rsv_period}┐ in the resource reservation period-┌log₂ N_{rsv_period}┐ information field.

For example, a period determined based on ┌log₂ N_{rsv_period}┐ in the resource reservation period-┌log₂ N_{rsv_period}┐ information field is P1, as shown in FIG. 6, the first terminal device initiates a COT of length M slots based on successful Listen-Before-Talk (LBT) at the first time, and sends COT sharing information to the second terminal device at the second time (slot N). A COT of length M starting from slot (N+P1) is reserved in the COT initiated at the first time, and a COT of length M starting from slot (N+2P1) is also reserved, that is, the first terminal device reserves a COT of length M starting from slot (N+gP1), where g is an integer greater than 1.

Another implementation is that if the resource reservation period-┌log₂ N_{rsv_period}┐ information field does not exist in the first-stage SCI, the third time includes one or more aperiodic times.

In the method for COT sharing provided in the embodiment of the present disclosure, in response to determining that the third time includes one or more aperiodic times, a time interval between the third time and the second time is less than or equal to a time threshold.

In the embodiment of the present disclosure, if it is determined that the third time includes one or more aperiodic times, the third time is blindly detected based on the time threshold, as long as the time interval between the third time and the second time is less than or equal to the time threshold, and no indication information is needed to indicate the specific third time.

In the method for COT sharing provided in the embodiment of the present disclosure, the time threshold is determined based on at least one of the following: a predefinition; a pre-configuration; or an indication from SCI.

In the method for COT sharing provided in the embodiment of the present disclosure, the number of third times is determined based on at least one of the following: a predefinition; a pre-configuration; or an indication from SCI.

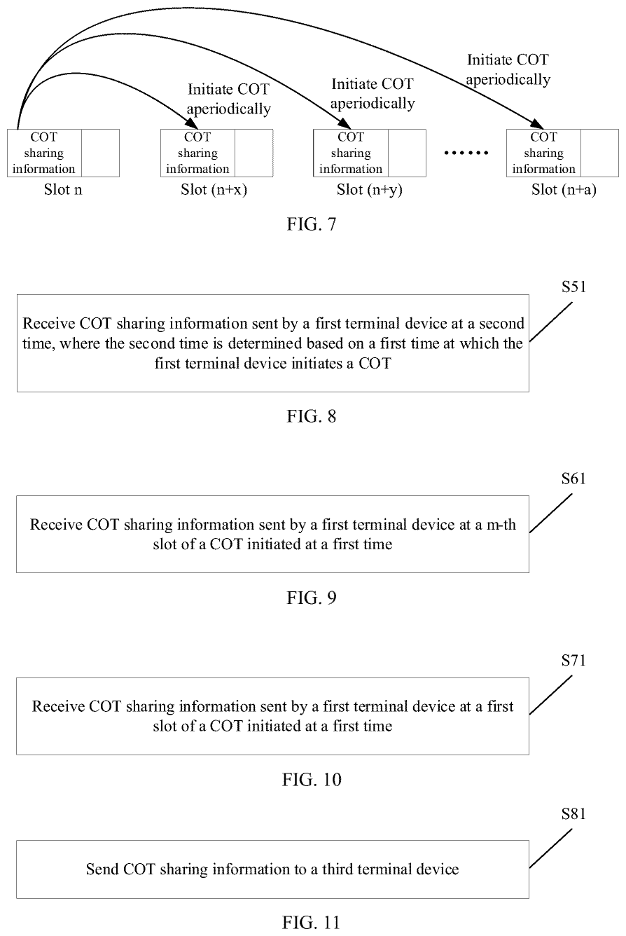

In an embodiment of the present disclosure, as shown in FIG. 7, the first terminal device initiates a COT of length M slots at the first time and sends COT sharing information to the second terminal device at the second time (slot N). The first indication information carried in the COT sharing information indicates the reservation of a COT of length M starting from slot (N+x) (x>M) and a COT of length M starting from slot (N+y) (y>M). The COT initiated at the first time can reserve up to “a” times of COT, with each reserved COT having a length of M slots, and the time interval between the first slot of the COT initiated at the first time and the first slot of the reserved “a” times of COT is distributed within the time threshold (b slots) at the longest.

For example, similar to the reserved resources of SCI in R16, the first slot of all reserved COTs and the first slot of COTs initiated at the first time are distributed between 32 slots.

In the present disclosure, by indicating that the COT(s) of the third time is reserved in the COT initiated at the first time periodically or aperiodically, signaling overhead is saved.

FIG. 8 is a flowchart of a method for COT sharing according to an embodiment of the present disclosure. As shown in FIG. 8, the method for COT sharing is performed by a second terminal device and includes the following step.

At step S51, receiving COT sharing information sent by a first terminal device at a second time, where the second time is determined based on a first time at which the first terminal device initiates a COT.

In the embodiment of the present disclosure, the first terminal device initiates the COT at the first time and sends the COT sharing information to the second terminal device at the second time. The second time is determined based on the first time. Therefore, in the embodiments of the present disclosure, the first terminal device can determine the time to send the COT sharing information based on the time of initiating the COT. Furthermore, the second terminal device can determine the second time to receive COT sharing information based on the first time when the first terminal device initiates the COT, and then receive the COT sharing information at the second time. This enables the second terminal device to receive and decode the COT sharing information in a timely and accurate manner, facilitating COT sharing based on the COT sharing information and improving the efficiency of COT sharing. In the method for COT sharing provided in the embodiment of the present disclosure, the COT sharing information can be received independently or together with communication data of the first terminal device.

In an implementation, the COT sharing information sent by the first terminal device can be received through direct communication; or, the MAC CE carries the COT sharing information, and the COT sharing information sent by the first terminal device can be received by receiving the MAC CE.

In the method for COT sharing provided in the embodiment of the present disclosure, the second time is equal to or later than the first time.

In an implementation of the method for COT sharing provided in the embodiment of the present disclosure, if the second time is later than the first time, the second time indicates a m-th slot of the COT initiated at the first time, and m is an integer greater than 1.

FIG. 9 is a flowchart of a method for COT sharing according to an embodiment of the present disclosure. As shown in FIG. 9, the method includes the following step.

At step S61, receiving COT sharing information sent by a first terminal device at a m-th slot of a COT initiated at a first time.

In the method for COT sharing provided in the embodiment of the present disclosure, if the second time is equal to the first time, the second time indicates a first slot of the COT initiated at the first time.

FIG. 10 is a flowchart of a method for COT sharing according to an embodiment of the present disclosure. As shown in FIG. 10, the method includes the following step.

At step S71, receiving COT sharing information sent by a first terminal device at a first slot of a COT initiated at a first time.

In the embodiment of the present disclosure, by receiving the COT sharing information sent by the first terminal device at the first slot of the COT initiated by the first terminal device, the second terminal device can receive the COT sharing information as early as possible and determine start position and end position of the COT used by the second terminal device, thereby reducing the time delay in decoding the COT sharing information.

In the embodiment of the present disclosure, each time the first terminal device initiates COT sharing, the first terminal device will send COT sharing information to the second terminal device once at the first slot or m-th slot when the COT is initiated, that is, the number of times the first terminal device initiates COT sharing is the same as the number of times the first terminal device sends COT sharing information.

In the method for COT sharing provided in the embodiment of the present disclosure, at least one reserved COT to be initiated at a third time is included in the COT initiated at the first time.

The third time includes one or more periodic times, or the third time includes one or more aperiodic times.

In the embodiment of the present disclosure, the number of times the first terminal device initiates a COT and the number of times the first terminal device sends COT sharing information are different. The first terminal device will reserve the at least one COT initiated at the third time when initiating the COT at the first time. It can be understood that after the first terminal device initiates COT sharing at a certain time, the second terminal device receives COT sharing information once at the second time. Thereafter, when the first terminal device initiates the COT at the third time, the second terminal device will not receive the COT sharing information sent by the first terminal device, and the second terminal device will directly use the reserved COT.

In the embodiment of the present disclosure, the length of the COT initiated at the first time and the reserved COT initiated at the third time are the same.

In the method for COT sharing provided in the embodiment of the present disclosure, the COT sharing information carries first indication information, and the first indication information indicates whether the at least one COT initiated at the third time is reserved in the COT initiated at the first time.

In an implementation of the method for COT sharing provided in the embodiment of the present disclosure, the first indication information includes bit information, and whether the at least one COT initiated at the third time is reserved is indicated by the bit information.

In an embodiment of the present disclosure, in response to the bit information being 1, the first terminal device reserves at least one COT initiated at the third time in the COT initiated at the first time. Or, in response to the bit information being 0, the first terminal device does not reserve at least one COT initiated at the third time in the COT initiated at the first time.

In the method for COT sharing provided in the embodiment of the present disclosure, in response to the at least one COT initiated at the third time is reserved in the COT initiated at the first time, it is determined that the third time includes one or more periodic times or one or more aperiodic times.

An implementation is to determine whether the third time is a periodic time based on first-stage sidelink control information (SCI).

In an embodiment of the present disclosure, if a resource reservation period-┌log₂ N_{rsv_period}┐ information field exists in the first stage SCI, the third time is determined to be a periodic time, and a period of the third time is determined based on ┌log₂ N_{rsv_period}┐ in the resource reservation period-┌log₂ N_{rsv_period}┐ information field.

Another implementation is that if the resource reservation period-┌log₂ N_{rsv_period}┐ information field does not exist in the first-stage SCI, the third time includes one or more aperiodic times.

In the method for COT sharing provided in the embodiment of the present disclosure, in response to determining that the third time includes one or more aperiodic times, a time interval between the third time and the second time is less than or equal to a time threshold.

In the embodiment of the present disclosure, if it is determined that the third time includes one or more aperiodic times, the third time is blindly detected based on the time threshold, as long as the time interval between the third time and the second time is less than or equal to the time threshold, and there is no indication information indicating the specific third time.

In the method for COT sharing provided in the embodiment of the present disclosure, the time threshold is determined based on at least one of the following: a predefinition; a pre-configuration; or an indication from SCI.

In the method for COT sharing provided in the embodiment of the present disclosure, the number of third times is determined based on at least one of the following: a predefinition; a pre-configuration; or an indication from SCI.

In the present disclosure, by indicating that the COT(s) of the third time is reserved in the COT initiated at the first time periodically or aperiodically, signaling overhead is saved.

In the method for COT sharing provided by the embodiment of the present disclosure, the second terminal device will also send the COT sharing information to a third terminal device.

FIG. 11 is a flowchart of a method for COT sharing according to an embodiment of the present disclosure. As shown in FIG. 11, the method includes the following step.

At step S81, sending COT sharing information to a third terminal device.

It should be noted that steps S81 can be implemented independently, or together with any embodiment of the present disclosure, and will not be repeated here.

In the method for COT sharing provided by the embodiment of the present disclosure, the second terminal device will also send the COT sharing information to the third terminal device in response to meeting a condition for sending the COT sharing information.

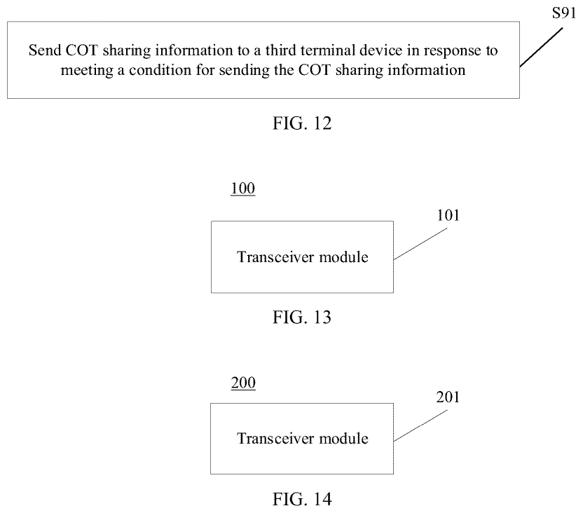

FIG. 12 is a flowchart of a method for COT sharing according to an embodiment of the present disclosure. As shown in FIG. 12, the method includes the following step.

At step S91, sending COT sharing information to a third terminal device in response to meeting a condition for sending the COT sharing information.

It should be noted that steps S91 can be implemented independently, or together with any embodiment of the present disclosure, and will not be repeated here.

In the method for COT sharing provided by the embodiment of the present disclosure, meeting the condition for sending the COT sharing information includes at least one of: a remaining COT length of a shared COT initiated by the first terminal device being not 0; or a multicast or broadcast communication mode being adopted with the first terminal device.

In an implementation, after receiving the COT sharing information sent by the first terminal device, the second terminal device determines the length of the COT shared with the first terminal device based on the COT sharing information. Furthermore, the second terminal device determines whether there will be any remaining COT in the COT shared with the first terminal device based on the number of slots required for its own data transmission. The remaining COT length of the shared COT initiated by the first terminal device is not 0, and the multicast or broadcast communication mode is adopted between the second terminal device and the first terminal device. That is, the COT sharing information is sent to the third terminal device connected to the second terminal device, and the COT sharing information carries the remaining COT in the COT shared with the first terminal device.

In the method for sharing COT provided by the embodiment of the present disclosure, the remaining COT length of the shared COT initiated by the first terminal device is 0; and/or, a unicast communication mode is adopted with the first terminal device, the second terminal device does not need to send the COT sharing information to the third terminal device.

It should be noted that those skilled in the art can understand that the above-mentioned various implementations/examples of the embodiments of the present disclosure can be used together with the aforementioned embodiments or independently. Whether used alone or in combination with the aforementioned embodiments, the implementation principle is similar. In the implementation of the present disclosure, some embodiments are explained in a way of using them together. Of course, those skilled in the art can understand that such examples are not limiting the embodiments of the present disclosure.

Based on the same concept, embodiments of the present disclosure further provide apparatuses for COT sharing.

It can be understood that, in order to realize the above functions, the apparatus for COT sharing provided by the embodiments of the present disclosure includes corresponding hardware structures and/or software modules for performing various functions. Combining the units and algorithm steps of various examples in embodiments of the present disclosure, the embodiments of the present disclosure can be realized in the form of hardware or a combination of hardware and computer software. Whether a function is executed by hardware or computer software drives hardware depends on the specific application and design constraints of the technical solution. Those skilled in the art can use different methods to realize the described functions for each specific application, but such implementation should not be considered beyond the scope of the technical solution of the embodiments of the present disclosure.

FIG. 13 is a block diagram of an apparatus for COT sharing 100 according to an embodiment of the present disclosure. Referring to FIG. 13, the apparatus 100 includes a transceiver module 101.

The transceiver module 101 is configured to initiate a channel occupancy time (COT) at a first time; and send COT sharing information to a second terminal device at a second time, where the second time is determined based on the first time.

In an implementation, the COT sharing information is sent independently, or the COT sharing information is sent together with communication data of the first terminal device.

In an implementation, the second time is equal to or later than the first time.

In an implementation, in response to determining that the second time is later than the first time, the second time indicates a m-th slot of the COT initiated at the first time, and m is a positive integer greater than 1.

In an implementation, in response to determining that the second time is equal to the first time, the second time indicates a first slot of the COT initiated at the first time.

In an implementation, at least one reserved COT initiated at a third time is included in the COT initiated at the first time.

The third time includes one or more periodic times, or the third time includes one or more aperiodic times.

In an implementation, the COT sharing information carries first indication information, and the first indication information indicates whether the at least one COT initiated at the third time is reserved in the COT initiated at the first time.

In an implementation, in response to determining that the third time includes one or more aperiodic times, a time interval between the third time and the second time is less than or equal to a time threshold.

In an implementation, the time threshold is determined based on at least one of: a predefinition; a pre-configuration; or indication from sidelink control information (SCI).

FIG. 14 is a block diagram of an apparatus for COT sharing 200 according to an embodiment of the present disclosure. Referring to FIG. 14, the apparatus 200 includes a transceiver module 201.

The transceiver module 201 is configured to receive COT sharing information sent by a first terminal device at a second time, where the second time is determined based on a first time at which the first terminal device initiates a COT.

In an implementation, the COT sharing information is received independently, or the COT sharing information is received together with communication data of the first terminal device.

In an implementation, the second time is equal to or later than the first time.

In an implementation, in response to determining that the second time is later than the first time, the second time indicates a m-th slot of the COT initiated at the first time, and m is a positive integer greater than 1.

In an implementation, in response to determining that the second time is equal to the first time, the second time indicates a first slot of the COT initiated at the first time.

In an implementation, at least one reserved COT initiated at a third time is included in the COT initiated by the first terminal device at the first time.

The third time includes one or more periodic times, or the third time includes one or more aperiodic times.

In an implementation, the COT sharing information carries first indication information, and the first indication information indicates whether the at least one COT initiated at the third time is reserved in the COT initiated by the first terminal device at the first time.

In an implementation, in response to determining that the third time includes one or more aperiodic times, a time interval between the third time and the second time is less than or equal to a time threshold.

In an implementation, the time threshold is determined based on at least one of: a predefinition; a pre-configuration; or indication from sidelink control information (SCI).

In an implementation, the transceiver module 201, is further configured to send COT sharing information to a third terminal device.

In an implementation, the transceiver module 201 is specifically configured to send the COT sharing information to the third terminal device in response to meeting a condition for sending the COT sharing information.

In an implementation, meeting the condition for sending the COT sharing information includes at least one of: a remaining COT length of a shared COT initiated by the first terminal device being not 0; or a multicast or broadcast communication mode being adopted with the first terminal device.

Regarding to the apparatus in the above embodiment, a specific way in which each module performs operations has been described in detail in the embodiments relating to the method, and will not be described in detail here.

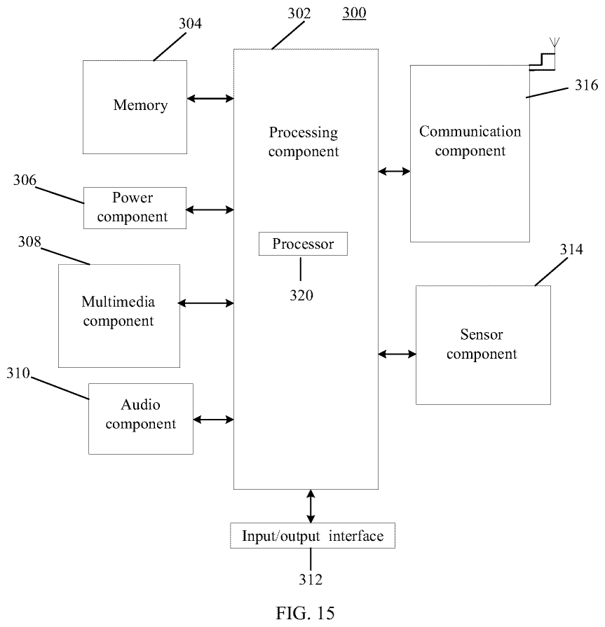

FIG. 15 is a block diagram of an apparatus for COT sharing according to an embodiment of the present disclosure. For example, the apparatus 300 may be a mobile phone, a computer, a digital broadcasting terminal, a messaging device, a game console, a tablet device, a medical device, a fitness device, a personal digital assistant, etc.

Referring to FIG. 15, the apparatus 300 may include one or more of the following components: a processing component 302, a memory 304, a power component 306, a multimedia component 308, an audio component 310, an input/output (I/O) interface 312, a sensor component 314, and a communication component 316.

The processing component 302 generally controls the overall operation of the apparatus 300, such as operations associated with display, telephone call, data communication, camera operation and recording operation. The processing component 302 may include one or more processors 320 to execute instructions to complete all or part of steps of the above-mentioned method. In addition, the processing component 302 may include one or more modules to facilitate interactions between the processing component 302 and other components. For example, the processing component 302 may include a multimedia module to facilitate interactions between the multimedia component 308 and the processing component 302.

The memory 304 is configured to store various types of data to support operations in the apparatus 300. Examples of these data include instructions of any application program or method for being operated on the apparatus 300, contact data, phone book data, messages, pictures, videos, etc. The memory 304 can be implemented by any type of volatile or non-volatile memory device or combinations thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic disk or optical disk.

The power component 306 provides power to various components of the apparatus 300. The power component 306 may include a power management system, one or more power supplies, and other components associated with generating, managing and distributing power for the apparatus 300.

The multimedia component 308 includes a screen that provides an output interface between the apparatus 300 and a user. In some embodiments, the screen may include a liquid crystal display (LCD) and a touch panel (TP). If the screen includes a touch panel, the screen may be implemented as a touch screen to receive an input signal from a user. The touch panel includes one or more touch sensors to sense touching, sliding and gestures on the touch panel. The touch sensor may not only sense a boundary of a touching or sliding action, but also detect a duration and a pressure related to the touching or sliding operation. In some embodiments, the multimedia component 308 includes a front camera and/or a rear camera. When the apparatus 300 is in an operation mode, such as a shooting mode or a video mode, the front camera and/or the rear camera can receive external multimedia data. Each front camera and rear camera may be a fixed optical lens system or have focal length and optical zoom capability.

The audio component 310 is configured to output and/or input audio signals. For example, the audio component 310 includes a microphone (MIC) configured to receive external audio signals when the apparatus 300 is in the operation mode, such as a calling mode, a recording mode and a voice recognition mode. The received audio signal may be further stored in the memory 304 or transmitted via the communication component 316. In some embodiments, the audio component 310 further includes a speaker for outputting audio signals.

The I/O interface 312 provides an interface between the processing component 302 and peripheral interface modules, where the peripheral interface modules may be keyboards, click-wheels, buttons, etc. These buttons may include, but are not limited to: home button, volume button, start button and lock button. The transceivers 101 and 201 may be for example an input/output device such as the I/O interface 312.

The sensor component 314 includes one or more sensors for providing various aspects of state evaluation for the apparatus 300. For example, the sensor component 314 can detect an on/off state of the apparatus 300, a relative positioning of components, for example, the components are the display and the keypad of the apparatus 300, and the sensor component 314 can also detect a position change of the apparatus 300 or a component of the apparatus 300, presence or absence of user contact with the apparatus 300, orientation or acceleration/deceleration of the apparatus 300 and a temperature change of the apparatus 300. The sensor component 314 may include a proximity sensor configured to detect presence of a nearby object without any physical contact. The sensor component 314 may also include an optical sensor, such as a CMOS or CCD image sensor, for use in imaging applications. In some embodiments, the sensor component 314 may further include an acceleration sensor, a gyroscope sensor, a magnetic sensor, a pressure sensor or a temperature sensor.

The communication component 316 is configured to facilitate wired or wireless communication between the apparatus 300 and other devices. The apparatus 300 can access a wireless network based on communication standards, such as WiFi, 2G or 3G, or combinations thereof. In an embodiment of the present disclosure, the communication component 316 receives a broadcast signal or broadcast related information from an external broadcast management system via a broadcast channel. In an embodiment of the present disclosure, the communication component 316 further includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an embodiment of the present disclosure, the apparatus 300 may be implemented by one or more application-specific integrated circuits (ASIC), digital signal processors (DSP), digital signal processing devices (DSPD), programmable logic devices (PLD), field programmable gate arrays (FPGA), controllers, micro-controllers, micro-processors or other electronic components, for executing the above-mentioned method.

In an embodiment of the present disclosure, a non-transitory computer-readable storage medium is further provided, such as the memory 304 including instructions, where the instructions can be executed by a processor 320 of the apparatus 300 to complete the above-mentioned delay determination method. For example, the non-transitory computer-readable storage medium may be an ROM, a random access memory (RAM), a CD-ROM, a magnetic tape, a floppy disk, an optical data storage device, etc.

It can be further understood that “plurality” in the present disclosure means two or more, and that other quantifiers are similar. “And/or”, which describes the relationship of related objects, means that there can be three kinds of relationships, for example, A and/or B, which can mean that A exists alone, A and B exist together, and B exists alone. The character “/” generally indicates that the associated object is an “or” relationship. Singular forms of “a”, “said”, and “the” are also intended to include majority forms, unless the context clearly indicates otherwise.

It can be further understood that the meanings of words such as “in response to” and “if” mentioned in the present disclosure depend on the context and the actual usage scenario. For example, the word “in response to” used herein can be interpreted as “at” or “when” or “if”.

It can be further understood that the terms “first”, “second”, etc. may be used to describe various information, but this information should not be limited to these terms. These terms are used only to distinguish the same type of information from one another and do not indicate a specific order or degree of importance. In fact, expressions such as “first” and “second” can be used interchangeably. For example, without departing from the scope of the present disclosure, first information can also be called second information, and similarly, the second information can also be called the first information.

It can be further understood that although the operations are described in a specific order in the accompanying drawings in the embodiments of the present disclosure, it should not be understood as requiring that these operations be performed in the specific order or serial order shown, or that all the operations shown should be performed to obtain the desired results. In certain circumstances, multitasking and parallel processing may be beneficial.

Other embodiments of the present disclosure will easily occur to those skilled in the art after considering the specification and practicing the present disclosure disclosed herein. The present disclosure is intended to cover any variations, uses or adaptations of the present disclosure, and these variations, uses or adaptations follow general principles of the present disclosure and include common sense or common technical means in the technical field that are not disclosed in the present disclosure.

It should be understood that the present disclosure is not limited to precise structures described above and shown in the accompanying drawings, and various modifications and changes can be made without departing from its scope. The scope of the present disclosure is limited only by the appended claims.

1. A method for channel occupancy time (COT) sharing, performed by a first terminal device and comprising:
initiating a COT at a first time; and
sending COT sharing information to a second terminal device at a second time, wherein the second time is determined based on the first time.

2. The method according to claim 1, wherein the COT sharing information is sent independently, or the COT sharing information is sent together with communication data of the first terminal device.

3. The method according to claim 1, wherein the second time is equal to or later than the first time.

4. The method according to claim 3, wherein in response to determining that the second time is later than the first time, the second time indicates a m-th slot of the COT initiated at the first time, and m is an integer greater than 1.

5. The method according to claim 3, wherein in response to determining that the second time is equal to the first time, the second time indicates a first slot of the COT initiated at the first time.

6. The method according to claim 1, wherein at least one COT initiated at a third time is reserved in the COT initiated at the first time, and
wherein the third time comprises one or more periodic times, or the third time comprises one or more aperiodic times.

7. The method according to claim 6, wherein the COT sharing information carries first indication information, and the first indication information indicates whether the at least one COT initiated at the third time is reserved in the COT initiated at the first time.

8. The method according to claim 6, wherein in response to determining that the third time comprises one or more aperiodic times, a time interval between the third time and the second time is less than or equal to a time threshold.

9. The method according to claim 8, wherein the time threshold is determined based on at least one of:
a predefinition;
a pre-configuration; or
an indication from sidelink control information (SCI).

10. A method for channel occupancy time (COT) sharing, performed by a second terminal device and comprising:
receiving COT sharing information sent by a first terminal device at a second time, wherein the second time is determined based on a first time at which the first terminal device initiates a COT.

11-12. (canceled)

13. The method according to claim 10, wherein the second time is equal to or later than the first time, and in response to determining that the second time is later than the first time, the second time indicates a m-th slot of the COT initiated at the first time, and m is an integer greater than 1.

14. The method according to claim 13, wherein in response to determining that the second time is equal to the first time, the second time indicates a first slot of the COT initiated at the first time.

15. The method according to claim 10, wherein at least one COT initiated at a third time is reserved in the COT initiated by the first terminal device at the first time, and
wherein the third time comprises one or more periodic times, or the third time comprises one or more aperiodic times.

16. The method according to claim 14, wherein the COT sharing information carries first indication information, and the first indication information indicates whether the at least one COT initiated at the third time is reserved in the COT initiated by the first terminal device at the first time.

17. The method according to claim 15, wherein in response to determining that the third time comprises one or more aperiodic times, a time interval between the third time and the second time is less than or equal to a time threshold.

18. (canceled)

19. The method according to claim 10, further comprising:
sending the COT sharing information to a third terminal device, and
wherein sending the COT sharing information to the third terminal device comprises:
sending the COT sharing information to the third terminal device in response to meeting a condition for sending the COT sharing information.

20. (canceled)

21. The method according to claim 19, wherein meeting the condition for sending the COT sharing information comprises at least one of:
a remaining COT length of a shared COT initiated by the first terminal device being not 0; or
a multicast or broadcast communication mode being adopted with the first terminal device.

22-23. (canceled)

24. A communication apparatus, comprising:
a processor; and
a memory, configured to store processor-executable instructions, and
wherein the processor is configured to perform:
initiating a channel occupancy time (COT) at a first time; and
sending COT sharing information to a second terminal device at a second time, wherein the second time is determined based on the first time.

25. A communication apparatus, comprising:
a processor; and
a memory, configured to store processor-executable instructions, and
wherein the processor executes the processor-executable instructions and performs the method according to claim 10.

26. A non-transitory computer-readable storage medium storing instructions and when the instructions are executed by a processor of a first terminal device, the first terminal device performs the method according to claim 1.

27-28. (canceled)
